(19) United States
(12) Patent Application Publication
(10) Pub. No.: US 2008/0240572 A1
(43) Pub. Date: Oct. 2, 2008

(54) Image Search Apparatus and Image Search Method

(75) Inventor: Jun HOSHII, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/050,816

(22) Filed: Mar. 18, 2008

(30) Foreign Application Priority Data
Mar. 26, 2007 (JP) 2007-078442
Nov. 9, 2007 (JP) 2007-291603

(51) Int. Cl. G06K 9/46

(52) U.S. Cl. 382/190

(57) ABSTRACT

An image search apparatus and method is provided for searching plural images stored in storage for specific images. The apparatus includes an object setting unit that sets plural objects on a certain region of a screen of the image search apparatus, each object having at least one attribute of shape, size, color, and texture; a feature extraction unit that extracts a relative positional relationship between the plural objects and an attribute of the respective object as a feature that is used when searching for the specific images; and an image extraction unit that extracts images having the extracted feature from the plural images stored in the storage.

### BACKGROUND

1. Technical Field

The present invention relates to a method and apparatus for searching images.

2. Related Art

In recent years, with the progress of computer-related technology, many people are storing their images as digital image data. By storing the images in the form of image data, a large mount of images can be stored in a small space with little cost. The image data can be read out at any time for the purpose of display or printing on an as needed basis.

However, when a large amount of images are stored as image data, locating the image data of particular images may become difficult. As an example of the related art for solving such a problem, JP-A-2000-339341 discloses a technology in which individual image data are stored with information, such as created date, referenced date, or number of references, to narrow down the image data and thus making it easy to locate the image data of particular images.

As another example, JP-A-2000-276483 discloses a technology in which individual image data are stored with several comments as an index representing the feature of image data to narrow down the image data and thus making locating it easy to locate the image data of particular images.

However, in the above-described technologies, it is still difficult to locate efficiently the image data of particular images among the large amount of image data. That is, according to the technology disclosed in JP-A-2000-339341, the created date, the referenced date, and the number of references are not directly related to the contents of images. Therefore, even when the image data are narrowed down based on such information, it may be difficult to locate efficiently the image data of particular images. Meanwhile, the technology disclosed in JP-A-2000-276483 can narrow down the image data by the contents of images; however, all the image data should have been indexed so the search can be successful. However, when users search for particular images using a feature as a keyword that was not thought of when the images were stored as the image data, it may be difficult to locate efficiently the image data of the particular images.

### SUMMARY

An advantage of some aspects of the invention is that it provides a method and apparatus that can efficiently locate image data of particular images among a large number of images stored as image data

In order to solve at least some of the problems mentioned above, according to an aspect of the invention, there is provided an image search apparatus that searches plural images stored in storage for specific images, the apparatus including: an object setting unit that sets plural objects on a certain region of a screen of the image search apparatus, each object having at least one attribute of shape, size, color, and texture; a feature extraction unit that extracts a relative positional relationship between the plural objects and an attribute of the respective object as a feature that is used when searching for the specific images; and an image extraction unit that extracts images having the extracted feature from the plural images stored in the storage.

According to another aspect of the invention, there is provided an image search method for searching plural images stored in storage for specific images, the method including: a first step of setting plural objects on a certain region of a screen, each object having at least one attribute of shape, size, color, and texture; a second step of extracting a relative positional relationship between the plural objects and an attribute of the respective object as a feature that is used when searching for the specific images; and a third step of extracting images having the extracted feature from the plural images stored in the storage.

According to the aspects of the image search apparatus and method of the present invention, plural objects having at least one attribute of shape, size, color, and texture are set on a certain region. A relative positional relationship between the plural objects and the attributes of the respective objects are extracted as a feature that is used when searching for specific images. Images having the extracted feature are searched and extracted from plural images stored in storage.

The relative positional relationship between the objects and the attributes of the objects can provide much greater information than a captured (created) date or a captured scene of an image. Therefore, by searching images based on the relative positional relationship between the objects and the attributes of the objects, it is possible to search the images more efficiently. In addition, the relative positional relationship and the attributes are easy to set and it is easily identifiable whether such a feature is found in images. Even when a number of images are stored in storage, it is possible to search and extract particular images quickly from the images stored in the storage.

When setting plural objects on a certain region, user may set objects on a computer screen or may draw objects on a sheet and then read the objects in an optical scanner so that the objects are set on a certain region of the screen.

In the above aspect of the image search apparatus of the present invention, when the plural objects are set with a size attribute, the feature extraction unit may extract a relative size relationship between the plural objects as the feature for use in the search.

By searching images based on the relative positional relationship between plural objects, it is possible to perform search regardless of the respective size of subjects photographed onto an image and thus making it possible to appropriately locate a particular image.

In the above aspect of the image search apparatus of the present invention, when the objects are set with the color attribute, the feature extraction unit may extract the color of the objects as the feature for use in the search.

In many cases, the subjects photographed onto an image can be narrowed down by colors as well as the sizes or shapes. Therefore, by searching images based on the color of the objects, it is possible to more appropriately locate a particular image.

In the above aspect of the image search apparatus of the present invention, the feature extraction unit may extract, as the feature for use in the search, a positional relationship of the plural objects with respect to the certain region as well as the relative positional relationship between the plural objects.

By doing this, the positions of the photographed subjects in an image can be taken into consideration during the image search. Therefore, it is possible to locate particular images in a more efficient manner.

In the above aspect of the image search apparatus of the present invention, the feature extraction unit may extract, as the feature for use in the search, the relative positional relationship between the plural objects in terms of any one of up, down, left, right, upper left, upper right, lower left, and lower right.

In practical use, the relative positional relationship between subjects can be expressed with sufficiently high precision by the eight directional classifications mentioned above. Therefore, by extracting the relative positional relationship between the objects in terms of such aspects, the image search can be performed in a simple manner with sufficiently high precision for practical use.

In the above aspect of the image search apparatus of the present invention, the feature extraction unit may extract, as the feature for use in the search, the relative positional relationship between the plural objects in a vertical or horizontal direction.

Some people may not want to designate in detail the relative positional relationship between subjects during the image search. For example, when people cannot remember where one subject was located relative to another subject when the subjects were photographed; for example, on the right side or on the upper right side, they may want to designate any of the directions to start the image search In such a case, by extracting the relative positional relationship between the objects in a horizontal direction and searching the images, it is possible to appropriately locate particular images. Needless to say, when the relative positional relationship is extracted in a vertical direction, the same advantage as mentioned above can be provided.

In the above aspect of the image search apparatus of the present invention, when there are three or more set objects, the feature extraction unit may extract a relative positional relationship between plural objects arbitrarily selected from the three or more objects as the feature for use in the search. In this case, the relative positional relationship is extracted between only parts of the entire objects. Specifically, plural objects are arbitrarily selected from three or more objects and the relative positional relationship between the selected objects is extracted as a feature that is used when searching for particular images. Here, since plural object sets can be selected from the plural objects, the relative positional relationship may be extracted between the objects in each of the plural object sets. And, images having the extracted feature may be searched from plural images.

When the number of set objects increases, the number of images extracted by the search tends to decrease, whereby users fail to find the particular images. In such a case, by making searchable the images satisfying the relative positional relationship not for the entire object sets but only parts of the sets, it is possible to locate the particular images.

The present invention can be embodied as a program for implementing the image search method described above, which is read into a computer, causing the computer to execute certain functions of the program. Therefore, such a program is also included in the scope of the present invention. According to a further aspect of the invention, there is provided a program for causing a computer to execute an image search method for searching plural images stored in storage for specific images, the program including: a first function of setting plural objects on a certain region of a screen, each object having at least one attribute of shape, size, color, and texture; a second function of extracting a relative positional relationship between the plural objects and an attribute of the respective object as a feature that is used when searching for the specific images; and a third function of extracting images having the extracted feature from the plural images stored in the storage.

When the program according to the aspect described above is read into a computer and the functions described above are executed, it is possible to efficiently locate image data of particular images among a large number of images stored as image data.

### BRIEF DESCRIPTION OF THE DRAWINGS

The invention will be described with reference to the accompanying drawings, wherein like numbers reference like elements.

FIG. 1 is an external perspective view showing an example of an image search apparatus according to an embodiment of the present invention.

FIGS. 2A to 2C are explanatory diagrams showing images obtained through a search based on a relative positional relationship between objects set on a feature setting region.

FIG. 3 is a flow chart showing an example of an image search process according to an embodiment of the present invention.

FIG. 4 is an explanatory diagram showing the way in which the relative positional relationship between set objects is extracted.

FIG. 5 is an explanatory diagram schematically showing a screen for setting detailed search conditions.

FIGS. 6A to 6C are explanatory diagrams for showing that changing the search condition enabled a more flexible search.

FIG. 7 is an explanatory diagram showing an example of an image obtained by a search under a condition that does not consider the shape of an object.

FIGS. 8A and 8B are explanatory diagrams showing two images in which a front-rear relationship between objects in an image is different.

### DESCRIPTION OF EXEMPLARY EMBODIMENTS

Hereinafter, embodiments of the invention will be described with reference to the accompanying drawings in the following order set below:

A. Construction of Apparatus and Summary of Search Method;

B. Image Search Process;

C. Modified Example;

C-1. First Modified Example;

C-2. Second Modified Example;

C-3. Third Modified Example; and

C-4. Fourth Modified Example.

### A. CONSTRUCTION OF APPARATUS AND SUMMARY OF SEARCH METHOD

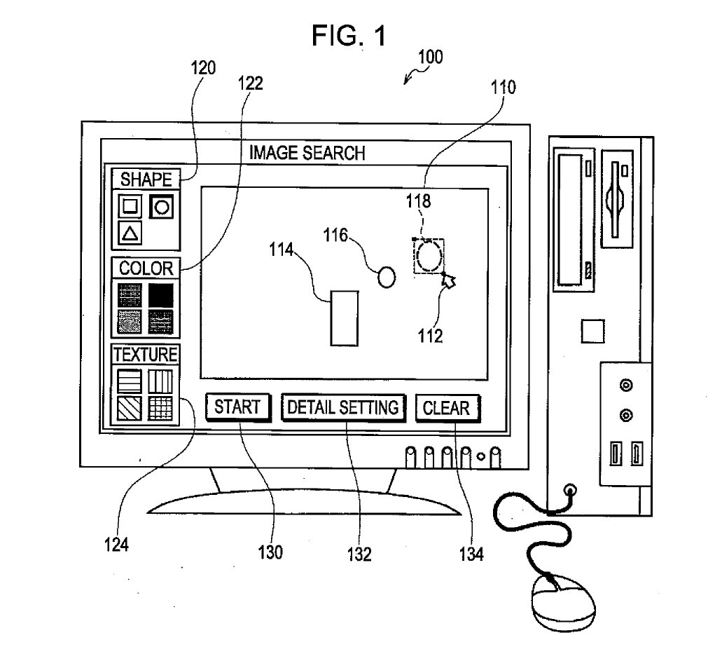

FIG. 1 is an external perspective view showing an example of an image search apparatus 100 according to an embodiment of the present invention. In the drawing, the image search apparatus 100 is embodied as a personal computer equipped with a monitor screen. As is widely known, in the personal computer, a RAM for temporarily storing data, a ROM for storing basic programs or data, a built-in hard disk for storing various application program or data and the like are connected to each other via a central processing unit (CPU) that performs arithmetic and logical operations so that data can be exchanged between them. When a large number of image data are stored in the built-in hard disk and a specific application program for an image search purpose installed in the built-in hard disk is activated, the personal computer can function as the image search apparatus 100 of the present embodiment.

Once the specific application program of the image search purpose is activated, an image search window as shown in FIG. 1 is displayed on the monitor screen of the image search apparatus 100. On the central part of the image search window, a large rectangular feature setting region 110 is provided. In the image search apparatus 100 of the present embodiment, simple figures (hereinafter referred to as an object) are set on the feature setting region 110 so as to designate a feature of an image(s) that a user is searching for. Beside the feature setting region 110, in the drawing, on the left side thereof, a shape palette 120 for designating the shape of the objects, a color palette 122 for designating the color of the objects, a texture palette 124 for designating the texture (for example, lines and stripes) of the objects are provided on the image search window. The user of the image search apparatus 100 can move a cursor 112 on the monitor screen to select one object from the shape pallet 120 and drags the curser 112 on the feature setting region 110 to designate a certain region, thereby setting the object of a desired size at a desired position. In addition, for each designated shape of the object, the shape may be deformed so as to extend in a vertical or horizontal direction.

In the example of FIG. 1, a vertically long rectangular object 114 is set on the central part of the feature setting region 110 and a vertically long elliptical object 116 is set on the upper right side of the rectangular object 114. On the upper right side of the elliptical object 116, the curser 112 drags to designate a region, whereby another elliptical object 118 is set. The elliptical object 118 and the region are shown in broken lines. This represents that they are deformable in a vertical or horizontal direction by dragging the curser 112; that is, they are in an unsettled state. According to the example, the region is designated in a vertically long shape and the object is also in a vertically long shape in a corresponding manner. When the designation is settled in such a state, a vertically long elliptical object 118 is set. The thus-set objects in the feature setting region 110 can be further rotated or deformed in a vertical or horizontal direction by operating the curser 112 on the objects.

As shown in FIG. 1, the shape palette 120 contains several simple figures such as a rectangle, a circle, or a triangle so that users can select a desired figure from the shape palette 120. Needless to say, users can appropriately add another figure in the shape palette according to the need. The color palette 122 contains various colors including chromatic colors such as red, blue, or yellow and achromatic colors such as black, white, or gray so that users can select a desired color from the color palette 122. Specifically, when setting an object on the feature setting region 110, users select a desired color from the color palette 122 to color the object. Needless to say, the coloring may be performed after the object is set by selecting the set object using the curser 112. It is noted that users can appropriately add another color in the color palette 122 according to the needs.

The texture palette 124 contains various textures such as vertical or horizontal lines, stripes, or polka dots (water drops) so that users can select a desired texture from the texture palette 124 to texture the object. The coloring and texturing may be simultaneously performed on a single object. For example, when users select red from the color palette 122 and vertical lines from the texture palette 124, the object can have an attribute that it contains vertical lines of red.

In the image search apparatus 100 of the present embodiment, once plural objects are set on the feature setting region 110 in a manner described above, the user presses a start button 130 on the lower part of the monitor screen to activate the specific application program installed in the image search apparatus 100. Then, the program extracts a relative positional relationship between objects set on the feature setting region 110 and additional information such as the shape, size, color, or texture of the objects. When the extraction is complete, the program search image data stored in the built-in hard disk of the image search apparatus 100 to find corresponding image data.

On the lower part of the monitor screen, besides the start button 130, a detailed setting button 132 and a clear button 134 are provided. The detailed setting button 132 is pressed to set a detailed condition for the image search. The detailed setting content of the search condition and the search result obtainable by using the search condition will be described later. The clear button 134 is pressed to clear the objects set on the feature setting region 110.

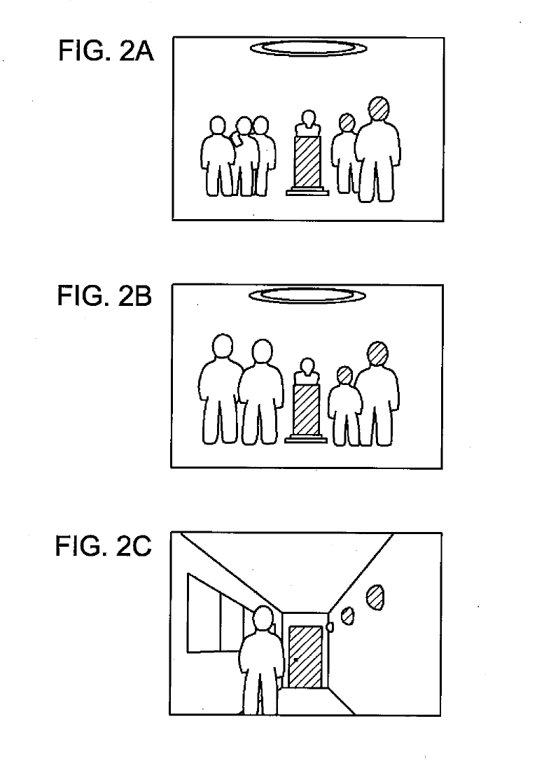

FIGS. 2A to 2C are explanatory diagrams showing images obtained through a search based on a relative positional relationship between objects set on the feature setting region 110. For example, assume that a vertically long rectangular object 114 is set on the central part of the feature setting region 110, a vertically long elliptical object 116 is set on the upper right side of the object 114, and another vertically long elliptical object 118 is set on the upper right side of the object 116, as shown in FIG. 1.

FIG. 2A shows an image captured in the vicinity of a statue. A vertically long base of the statue is photographed onto the center of the image and three people are standing on the left side of the statue and two people are standing on the right side of the statue. The person on the right-most side of the statue is short and the person's head is photographed onto the upper right side of the statue. The other person on the right side of the statue is tall and the person's head is photographed onto the more upper right side of the statue. The base part of the statue is of a vertically long rectangular shape and the head of people is of a vertically long elliptical shape. Taking an image of the right part of the image including the base of the state and the two people on the right side thereof, the image contains the vertically long rectangle and the two vertically long ellipses, which exactly match the relative positional relationship set on the feature setting region 110 shown in FIG. 1. In FIG. 2A, for the convenience of understanding, the rectangle and the ellipses are shown by hatched lines.

FIG. 2B shows another image captured in the vicinity of the same statue. Although the arrangement or the number of persons around the statue is different from that of FIG. 2A, in this image, a vertically long rectangular statue is photographed onto the central part of the image, a person's head is photographed onto the upper right side of the statue, and another person's head is photographed onto the more upper right side of the statue. In FIG. 2B, the rectangle and the two ellipses are also shown by hatched lines. As is obvious when the images of FIGS. 2A and 2B with each other, although the two images are different in terms of the arrangement or the number of persons contained therein, the two images are identical in that a vertically long rectangle is photographed onto the respective centers of the images and two vertically long ellipses are photographed onto the respective upper right sides of the images. In this respect, in a manner described above with reference to FIG. 1, by setting a rectangular object 114 on the central part of the feature setting region 110 and an elliptical object 116 on the upper right side and another elliptical object 118 on the more upper right side, it is possible to find such images at once.

FIG. 2C shows a snap-shot image captured in the hallway. This image is completely different from the two images in terms of the photographed subjects and the composition. Specifically, a vertically long rectangular door is photographed onto the central part of the image, a hooded lamp of a circular shape is photographed onto the upper right side of the door, and another lamp of the same shape is photographed onto the more upper right side of the door. In FIG. 2C, the door and the two lamps are also shown by hatched lines. Attending on the relative positional relationship between the photographed subjects with hatched lines, this image is identical to the images shown in FIGS. 2A and 2B, in that a vertically long rectangle is photographed onto the respective centers of the images and two vertically long ellipses are photographed onto the respective upper right sides of the images. Therefore, in a manner described above with reference to FIG. 1, when a rectangular object 114 is set on the central part of the feature setting region 110 and an elliptical object 146 is set on the upper right side and another elliptical object 118 is set on the more upper right side, the image as shown in FIG. 2C may be output as the search result.

In this way, according to the image search apparatus 100 of the present embodiment, plural objects are set on the feature setting region 110 and images are searched based on the relative positional relationship between the objects. Therefore, it is possible to search images in a very flexible manner. However, when the images are searched based on a captured date or a capturing environment (captured scene) as was performed in the related art, it may be difficult to find at once three images as shown in FIGS. 2A to 2C. To the contrary, the image search apparatus 100 according to the present embodiment can find such images in a flexible manner.

Since such a flexible search can be performed by only arranging plural objects in the feature setting region 110, the search condition can be set in a very simple manner Moreover, since the relative positional relationship between the plural objects is extracted, even with such a simple search condition setting, the images can be searched based on adequately rich information compared with the captured date or the capturing environment (captured scene). For this reason, it is possible to appropriately locate, among a large amount of images, only the images that are similar to a particular image. Even with such a flexible search capability, since the images are searched based on the relative positional relationship between the objects of a simple shape, it does not excessively complicate the process of searching images. For this reason, it is possible to locate a particular image quickly from a large number of images.

### B. IMAGE SEARCH PROCESS

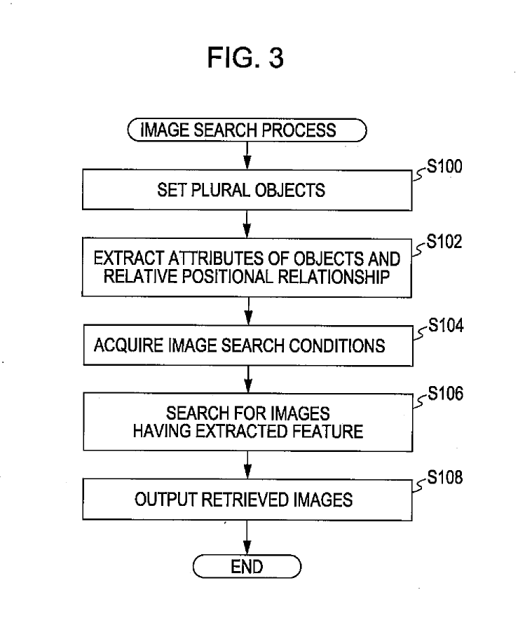

FIG. 3 is a flow chart showing an example of an image search process performed by the image search apparatus 100 according to the present embodiment of the present invention. The image search process described with reference to FIGS. 1 and 2 is realized when an application program installed in the image search apparatus 100 executes processes shown in FIG. 3. The details of the image search process will be described with reference to the flow chart of FIG. 3.

Once the image search process is initiated, plural objects are set on the feature setting region 110 of the monitor screen of the image search apparatus 100 (Step S100). As described above with reference to FIG. 1, the object setting step is performed by the user of the image search apparatus 100 wherein the user moves the curser 112 on the monitor screen of the image search apparatus 100 to select one object of a desired shape from the shape palette 120, and wherein the user drags the curser 112 on the feature setting region 110 to designate a certain region, thereby setting the object in the region. In the present embodiment, the shape palette 120 contains three objects having a rectangular, circular and triangular shape so that the user can select and designate the shape of an object. When a vertically long region is set on the feature setting region 110, the shape of the object in the region is deformed so as to be extended vertically long. When a horizontally long region is set on the feature setting region 110, the shape of the object in the region is deformed so as to be extended horizontally long. When the user selects with the curser 112 an object set in advance in the feature setting region 110, the user can enlarge, reduce, deform or rotate the object. According to the needs, the user can also select a color or a texture from the color palette 122 or the texture palette 124, thereby coloring or texturing the object in a desired manner. In Step S100 of the image search process shown in FIG. 3, the plural objects are set in the feature setting region 110 in a manner described above.

In the above description, the objects are set by selecting the objects from the shape palette 120 on the monitor screen of the image search apparatus 100. However, the object setting method is not limited to this method and a different method may be used as long as the method can set plural objects having a simple shape on the feature setting region 110. For example, the user may draw plural objects on a sheet or a display panel and read the objects in an optical scanner so that the objects are set on a certain region of the monitor screen.

Next, the attribute of the respective objects set on the feature setting region 110 and the relative positional relationship between the objects are extracted (Step S102). Here, the attribute of the object refers to the shape (rectangular, circular, vertically long, or horizontally long), size (a relative size to the feature setting region 110), color, and texture of the object, which is a feature of the object designated by the user when the object is set. Since plural objects are set on the feature setting region 110, the relative positional relationship between the objects can be extracted. According to an aspect of the image search process of the present embodiment, where one object is located relative to another object; for example, on the upper, lower, left, or right side of the another object, that is, the relative positional relationship between the objects is extracted in terms of such four simple classifications.

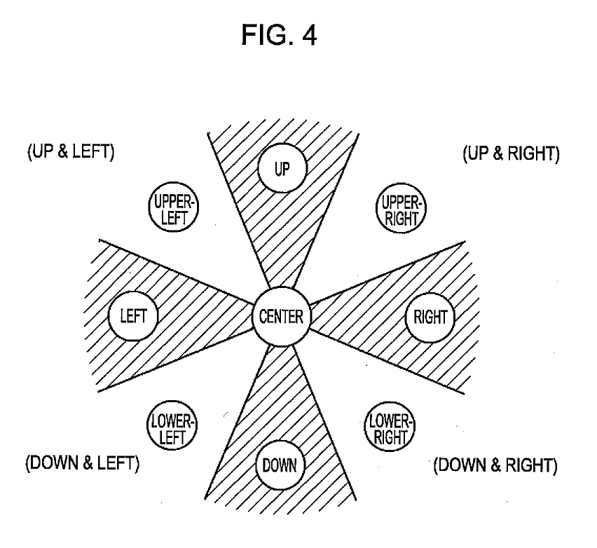

FIG. 4 is an explanatory diagram showing the way in which the relative positional relationship between set objects is extracted. In the drawing, the hatched regions correspond to four basic directions; up, down, right, and left. Moreover, four intermediate directions; upper left, upper right, lower left, and lower right, are expressed in combination of the four basic directions, wherein an upper left direction is a combination of up and left, an upper right direction is a combination of up and right, a lower left direction is a combination of down and left, and a lower right direction is a combination of down and right. In this manner, in the present embodiment, the relative positional relationship between the respective objects is extracted in terms of only one of the eight directions obtained by combining the four basic directions and the four intermediate directions; up, down, left, right, upper left, upper right, lower left, and lower right. Since the relative positional relationship between the respective objects is extracted in terms of such a simplified direction, it is possible to quickly extract the relative positional relationship between the respective objects even when a large number of objects are set.

In addition to the eight positional relationships described above, a front-rear relationship may be extracted in terms of front or rear. By extracting the front-rear relationship, it is possible to extract and designate a positional relationship that one is in front of but not on the upper, lower, left, and right side of the other or a positional relationship that one is on the right side of the other and in rear of the other, for example.

In Step S102 of the image search process shown in FIG. 3, the attribute of the respective objects set on the feature setting region 110 and the relative positional relationship between the objects are extracted in a manner described. In the present embodiment, in addition to the relative positional relationship between the respective objects, a positional relationship with respect to the feature setting region 110 is also extracted. The positional relationship with respect to the feature setting region 110 may be extracted in terms of a side on which the individual object is set on the feature setting region 110. Alternatively, the positional relationship may be extracted in terms of a side on which the plural objects are generally set on the feature setting region 110.

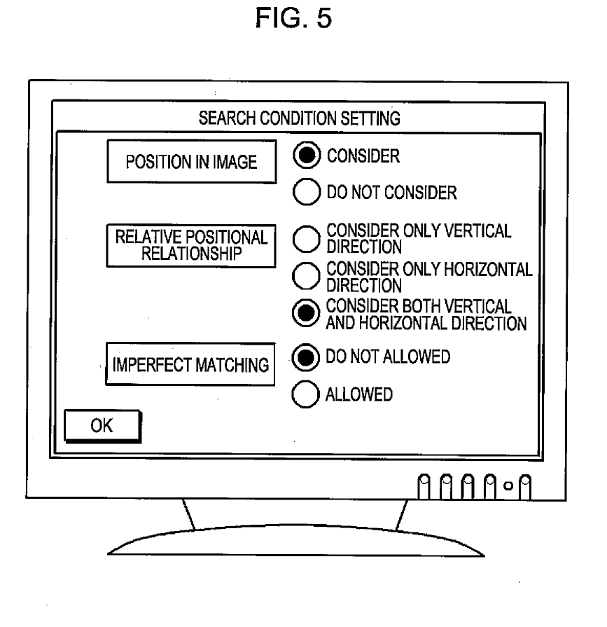

Once the attribute of the respective objects set on the feature setting region 110 and the relative positional relationship between the objects are extracted in the above-described manner, an image search condition is acquired (Step S104). In the present embodiment, three criteria as shown in FIG. 5 are provided as the image search condition. As a first criterion, users select whether the positional relationship of the individual objects with respect to the feature setting region 110 is considered or not. As a second criterion, users select which direction the relative positional relationship between the objects will be extracted. As a third criterion, users select whether or not they will search for only the images satisfying the attribute of the entire objects and the relative positional relationship thereof. To input the search criteria, users press the detailed setting button 132 provided on the bottom of the monitor screen shown in FIG. 1. Then, a window for setting the search condition shown in FIG. 5 is displayed so that users can select detailed search conditions on the window. In Step S104 of the image search process, the image search condition is acquired in the above described manner.

The three search conditions are set as shown in FIG. 5 unless the user changes the settings. That is, according to a standard search condition shown in FIG. 5, the position of the individual objects on the feature setting region 110 is considered, the relative positional relationship between the respective objects is considered in both vertical and horizontal directions, and only the images satisfying the attribute of the entire objects set on the feature setting region 110 and the relative positional relationship are searched for. By changing the search conditions, it is possible to perform the search in a more flexible manner. In addition to the search conditions, users may add as the search condition whether the front-rear relationship between objects will be considered or not. In this paragraph, the standard search condition shown in FIG. 5 is described for convenience of understanding. The changing of the search condition will be described later.

Next, images having the feature (including the attribute of the objects and the relative positional relationship) extracted from the plural objects set on the feature setting region 110 are search for based on the search condition acquired in the preceding step (Step S106). During this search, the image data stored in the built-in hard disk of the image search apparatus 100 or the like are analyzed to determine whether the images have the feature. In this case, the location such as a drive or folder may be designated so that only the image data in the designated drive or folder are analyzed. In addition, according to the needs, users can change a threshold for determining whether the analyzed image data have the feature extracted from the objects or not.

When images having the extracted feature are found, the images are displayed on the monitor screen (Step S108). The images may be displayed as a thumbnail image or in a text format with a file name that users click or select to see the image. The three images shown in FIGS. 2A to 2C are part of images obtained by the search based on the plural objects set on the feature setting region 110 of FIG. 1. In this way, when the retrieved images are displayed, the image search process shown in FIG. 3 ends.

As described above, according to the image search process of the present embodiment, images are searched based on the attribute of the plural objects set on the feature setting region 110 and the relative positional relationship between the objects. Here, the attribute of the object used in the present embodiment is relatively simple information such as the shape, size, color, or texture of a simple figure such as a rectangle or a circle (including an ellipse). Moreover, the relative positional relationship between the objects used in the present embodiment is relative simple information, which is a combination of four basic directions (up, down, left, and right). Nevertheless, such simple information can provide adequately rich information compared with the captured date or the capturing environment (captured scene) of an image or the index set when an image is stored. For this reason, it is possible to appropriately locate a particular image from a large amount of store images. When images are searched based on the captured date or the captured scene, images of which the captured date or scene are different from those set in the search condition are not retrieved. In the image search process of the present embodiment, it is possible to perform the image search in a very flexible manner regardless of the captured date or the captured scene.

Since the attribute of the object and the relative positional relationship used as the feature for use in the image search is easy to identify, it is relatively easy to determine whether the stored images have such a feature or not. For this reason, it is possible to quickly locate corresponding images from a large number of stored images without much complicating the image search process.

In this way, the image search process of the present embodiment can enable a flexible search and extend the flexibility by changing the search condition. This will be described in detail below.

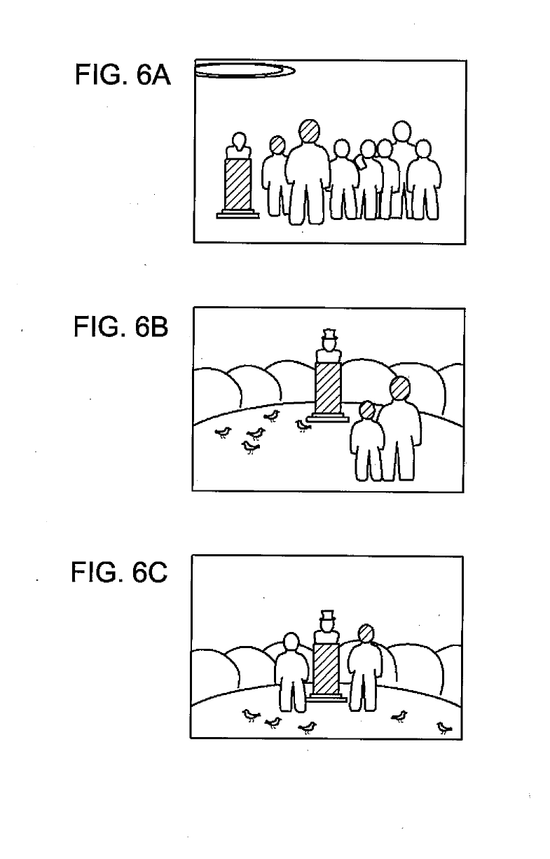

FIGS. 6A to 6C are explanatory diagrams for showing that changing the search condition enabled a more flexible search. The search condition includes the three criteria as shown in FIG. 5, as set below in brief. First, users select whether the position of the individual objects on the feature setting region 110 will be considered or not. Second, users select which of the vertical and horizontal directions the relative positional relationship between the respective objects will be extracted. Third, users select whether or not they will search for only the images satisfying the attribute of the entire objects set on the feature setting region 110 and the relative positional relationship thereof.

FIG. 6A shows an example of a retrieved image obtained when users selects “Do not consider” in the first search criterion of FIG. 5 on whether the position of the individual objects on the feature setting region 110 will be considered or not. As described above, according to the users' settings, a vertically long rectangular object is set on the central part of the feature setting region 110 and two elliptical objects are set on the upper right side. When the first search criterion is changed to “Do not consider” on the search condition setting screen shown in FIG. 5, it is possible to perform the image search without considering where the objects are photographed on the image while considering the relative positional relationship between the three objects. For example, in the image shown in FIG. 6A, several peoples are photographed on the central part of the image and a statue is photographed on the left side of the image. As shown by the hatched lines in FIG. 6A, the relative positional relationship between the base part of the statue and the heads of the two persons photographed on the right side of the statue is exactly identical to the relative positional relationship between the rectangular object 114 set on the feature setting region 110 and the two elliptical objects 116 and 118. Such an image is also retrieved.

FIG. 6B shows an example of a retrieved image obtained when users selects “Consider only horizontal direction” in the second search criterion of FIG. 5 on which of the vertical and horizontal directions the relative positional relationship between the respective objects will be extracted. As described above, according to the users settings, a vertically long rectangular object is set on the central part of the feature setting region 110 and two elliptical objects are set on the upper right side. As described with reference to FIG. 4, the positional relationship is identified by four basic directions; up, down, left, and right. For example, the upper right direction means that one is on the right side and the upper side of the other. When the second search criterion is changed to “Consider only horizontal direction,” the vertical directional positional relationship between the objects is not considered. Therefore, it is possible to find such an image in which an elliptical object is photographed on the right side (including upper right and lower right) of a rectangular image and another elliptical image is photographed on the more right side (including upper right and lower right) of the rectangular image. When a rectangular object is on the central part of an image, the vertical directional positional relationship may not be considered. As a result, in the image shown in FIG. 6B, although the base of a statue is photographed slightly above the center of the image and two persons are photographed on the lower right side of the base, such an image is also retrieved.

When users selects “Allow imperfect matching” in the third search criterion of FIG. 5 on whether or not they will search for only the images satisfying the attribute of the entire objects and the relative positional relationship thereof, the image search can be performed in the following manner. For example, on the feature setting region 110 shown in FIG. 1, three objects are set including a rectangular object on the central part, an elliptical object on the upper right side, and another elliptical object on the more upper right side. Of the three objects, it may be possible to extract the relative positional relationship between the two elliptical objects except the rectangular object. Alternatively, the relative positional relationship between the rectangular object and only one of the elliptical objects may be extracted.

When there are more than three objects set thereon, by eliminating some of the objects or selecting arbitrary two or more objects from the entire objects, it is possible to extract the relative positional relationship for plural object sets. When the third search criterion in FIG. 5 is changed to “Allow imperfect matching,” it is possible to find all the images satisfying any one of the relative positional relationships extracted for the plural object sets. For example, in the image shown in FIG. 6C, although a statue is photographed onto the central part, only one person is photographed on the right side of the statue. Therefore, this image does not perfectly satisfy the relative positional relationships of the entire objects set by the user. However, as shown by the hatched lines in the drawing, attending on the base part of the statue and the head of the standing person on the right side, the objects satisfy the relative positional relationship between the rectangular object and the elliptical object set by the user. Therefore, such an image is also retrieved.

As described above, according to the image search process of the present embodiment, plural objects are set on the feature setting region 110, and images are searched based on the feature of the image, the feature including the attribute the object and the relative positional relationship between the objects. Since the attribute of the object and the relative positional relationship between the objects are simple information, they are easy to set and identify. Nevertheless, such simple information can provide adequately rich information compared with the captured date or the capturing environment (captured scene) of an image or the index set when an image is stored. For this reason, it is possible to appropriately locate a particular image from a large amount of store images. Since the simple information can provide such rich information, it is possible to efficiently perform the image search even when some of the search conditions are not considered. Since users can appropriately select the search conditions, user can find a suitable search condition while monitoring the search result. Therefore, it is possible to perform the image search in a very flexible and appropriate manner.

### C. MODIFIED EXAMPLE

The image search process of the present embodiment described above can be modified in various ways. Hereinafter, a modified example of the present embodiment will be described briefly.

### C-1. First Modified Example

In the embodiment described above, since users can select objects that will not be considered in the image search, all of the attributes of the objects that users selected to consider are considered. However, users may select some of the attributes the set objects have and perform the image search. Alternatively, users may designate or select some attributes of the object that the users do not want to consider during the image search. At this time, as the attributes designated, the users can select several attributes such as the shape, size, color, or texture of the object.

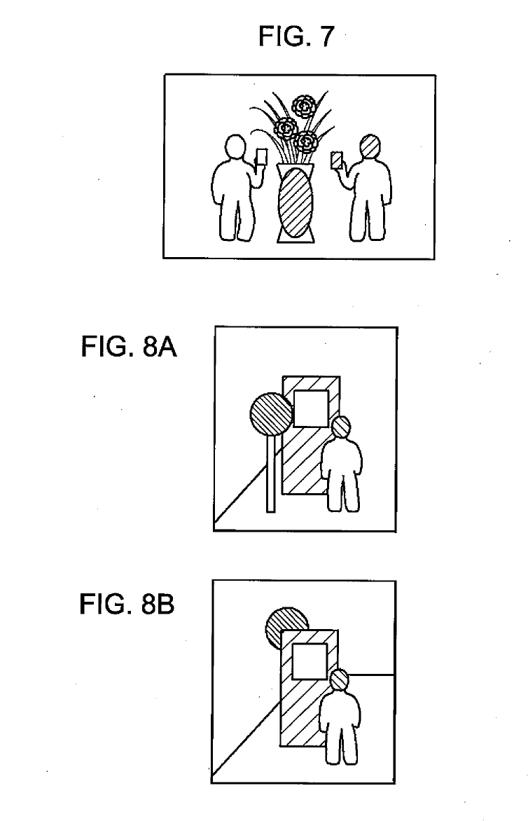

FIG. 7 is an explanatory diagram showing an example of an image obtained by a search under a condition that does not consider the shape of an object. As shown in FIG. 1, on the feature setting region 110, the user has set a rectangular object on the central part and two elliptical objects on the upper right side of the object. In the image shown in FIG. 7, a large elliptical flower vase is photographed onto the central part and a person is photographed on the right side of the flower vase. Moreover, a jug on the hand of the person is photographed as a rectangle on the upper right side of the flower vase and the head of the person is photographed on the more upper right side of the jug. The size of the elliptical flower vase, the mug, and the head of the person photographed on the image and the relative positional relationship between them are identical to the size the three objects set on the feature setting region 110 by the user and the relative positional relationship between them. However, the two images are different in shape. Therefore, by performing the image search without considering the shape of the object of the conditions set by the user, the image shown in FIG. 7 is also retrieved.

Needless to say, instead of the shape of the object, the image search may be performed without considering the size or color of the object. In addition, it is also possible to select individual objects from the entire objects set by the user and to perform the image search without considering the attribute such as the shape or size of the selected objects. By doing this, even when some of the subjects photographed on the image are difficult to determine the attribute, by eliminating such an attribute from the search conditions, it is possible to obtain a stable search result.

### C-2. Second Modified Example

The front-rear relationship between subjects photographed on the image may be detected and considered during the image search. For example, in both of the two images shown in FIGS. 8A and 8B, a vertically long rectangular telephone booth is photographed on the central part of the image, a circular traffic sign is photographed on the left side, and a person is photographed on the right side. However, attending on the overlapping parts in each image, in the image shown in FIG. 8A, the traffic sign and the person are on the front side and the telephone booth is on the rear side. To the contrary, in the image of FIG. 8B, the person is on the front side, the traffic sign is on the rear side, and the telephone booth is between them. That is, although the two images shown in FIGS. 8A and 8B are identical to each other in that the circular traffic sign and the person are photographed on the left and right sides of the vertically long rectangular telephone box, respectively, they are different in the positional relationship in the front-rear direction.

The front-rear relationship between subjects photographed on an image can be determined in a relatively easy manner by analyzing the image based on the following assumption. That is, assume that a subject photographed on an image has a relatively simple shape such as a rectangle, a circle, an ellipse, or a triangle. As the assumed shape, the simple shape described above may be set in advance or the shape contained in the shape palette 120 may be used. If the subject photographed on the image has such a simple shape, it is determined that there are no subjects photographed on the front side of the subject. Conversely, if the subject does not have a simple shape, it can be reasoned that the subject originally has a simple shape and another subject in front of the subject covers some parts of the subject. Therefore, it is determined that the subject is photographed on the rear side of the another subject.

For example, in the example shown in FIG. 8A, though a telephone booth is generally of a rectangular shape, some parts of the telephone booth is missing. Therefore, it can be determined that the telephone booth is photographed on the rear side of another subject. On the other hand, the traffic sign is photographed as a substantially perfect circle and the head of the person is photographed as a substantially elliptical shape; that is, there are no missing parts in the subjects. Therefore, it can be determined that these subjects are on the most front side.

In the example shown in FIG. 8B, the head of the person is photographed as a substantially elliptical shape with no missing parts. On the other hand, the telephone booth is photographed as a rectangular shape with missing parts. Therefore, it can be determined that the telephone booth is photographed on the rear side of another subject. In addition, the traffic sign is photographed as a circular shape with missing parts. Therefore, it can be determined that the traffic sign is photographed on the rear side of another subject. Now, in this reasoning step, it can be determined that the head of the person is photographed on the most front side and the telephone booth or the traffic sign is photographed on the rear side of the head of the person. The front-rear relationship between the telephone booth and the traffic sign can be determined by identifying the positional relationship of the subjects on the image. That is, the missing parts of the circle of the traffic sign are located on the same position as the missing part of the telephone booth. Therefore, it can be determined that the traffic sign is photographed on the rear side of the telephone booth. In this way, by analyzing the image based on an assumption that the subject has a simple shape, it is possible to extract the front-rear relationship between subjects from an image.

By allowing the user to set the front-rear relationship between objects when the user set plural objects on the feature setting region 110, the user can perform the image search considering the front-rear relationship between the objects. By doing this, it is possible to differentiate the two images shown in FIGS. 8A and 8B and thus making the image search more effective.

### C-3. Third Modified Example

In the embodiment described above, as the relative positional relationship between objects, eight roughly classified directions and the distance between the objects were considered. Here, the distance between objects may be detected by the actual separation between pixels. The distance may be detected by the distance between objects based on the size of the feature setting region 110. For example, the distance between objects may be expressed in terms of its ratio to a reference length such as the length of the long or short side of the feature setting region 110 or the diagonal line.

During the image search, according to the demands, the relative positional relationship between object may be considered in terms of only one of the distance and the direction. If a particular image is not found from the retrieved images, by performing the image search without considering one of the distance or the direction of the objects to extract more images which were extracted in the previous search, it becomes possible to locate a particular image.

### C-4. Fourth Modified Example

According to the embodiment described above, it is possible to apply a color attribute to an object. However, regarding such an object colored with a specific color, the search criterion may be set loose. That is, colors such as cherry or flesh color are somehow usable in estimating what the photographed subject is. For example, a photographed subject colored in cherry is highly likely to be a flower no matter which shape the subject has. A photographed subject colored in flesh color is highly likely to be a human or a part of the person unless the shape of the subject differs much from that of a human. Therefore, regarding a photographed subject colored in such specific colors, it may be possible to extract images having such a subject as belonging to an image satisfying the search condition no matter the shape or size of the subject differs somehow from that the user have in mind. Accordingly, it may be desirable to prepare such special colors in the color palette 122 or make the user easy to set such colors according to the needs.

Although the exemplary embodiments of the image search apparatus of the invention have been described with reference to the accompanying drawings, it should be understood that the invention is not limited to such embodiments. Various shapes or combinations of respective constituent elements illustrated in the above-described embodiments are merely examples, and various changes may be made depending on design requirements or the like without departing from the spirit or scope of the invention.

What is claimed is:

1. An image search apparatus that searches plural images stored in storage for specific images, the apparatus comprising:
an object setting unit that sets plural objects on a certain region of a screen of the image search apparatus, each object having at least one attribute of shape, size, color, and texture;
a feature extraction unit that extracts a relative positional relationship between the plural objects and an attribute of the respective object as a feature that is used when searching for the specific images; and
an image extraction unit that extracts images having the extracted feature from the plural images stored in the storage.

2. The image search apparatus according to claim 1, wherein the feature extraction unit, when the plural objects are set with a size attribute, extracts a relative size relationship between the plural objects as the feature for use in the search.

3. The image search apparatus according to claim 1,
wherein the object setting unit sets the objects so as to have a color attribute, and
wherein the feature extraction unit, when the objects are set with the color attribute, extracts the color of the objects as the feature for use in the search.

4. The image search apparatus according to claim 1, wherein the feature extraction unit extracts, as the feature for use in the search, a positional relationship of the plural objects with respect to the certain region as well as the relative positional relationship between the plural objects.

5. The image search apparatus according to claim 1, wherein the feature extraction unit extracts, as the feature for use in the search, the relative positional relationship between the plural objects in terms of any one of up, down, left, right, upper left, upper right, lower left, and lower right.

6. The image search apparatus according to claim 1, wherein the feature extraction unit extracts, as the feature for use in the search, the relative positional relationship between the plural objects in a vertical or horizontal direction.

7. The image search apparatus according to claim 1,
wherein the feature extraction unit, when there are three or more set objects, extracts a relative positional relationship between plural objects arbitrarily selected from the three or more objects as the feature for use in the search, and
wherein the image extraction unit extracts, from the plural images stored in the storage, images having the feature extracted from the arbitrarily selected plural objects.

8. An image search method for searching plural images stored in storage for specific images, the method comprising:
a first step of setting plural objects on a certain region of a screen, each object having at least one attribute of shape, size, color, and texture;
a second step of extracting a relative positional relationship between the plural objects and an attribute of the respective object as a feature that is used when searching for the specific images; and
a third step of extracting images having the extracted feature from the plural images stored in the storage.

9. A program for causing a computer to execute an image search method for searching plural images stored in storage for specific images, the program comprising:
a first function of setting plural objects on a certain region of a screen, each object having at least one attribute of shape, size, color, and texture;
a second function of extracting a relative positional relationship between the plural objects and an attribute of the respective object as a feature that is used when searching for the specific images; and
a third function of extracting images having the extracted feature from the plural images stored in the storage.
